(19) United States
(12) Patent Application Publication
(10) Pub. No.: US 2024/0262953 A1
(43) Pub. Date: Aug. 8, 2024

(54) THERMOPLASTIC ELASTOMER WITH EXCELLENT RESILIENCE AND HIGH STRENGTH AND PREPARATION METHOD THEREOF

(71) Applicant: NINGBO INSTITUTE OF MATERIALS TECHNOLOGY AND ENGINEERING, CHINESE ACADEMY OF SCIENCES, Ningbo, Zhejiang (CN)

(72) Inventors: Haiming CHEN, Ningbo, Zhejiang (CN); Zaizheng SUN, Ningbo, Zhejiang (CN); Dongsheng MAO, Ningbo, Zhejiang (CN)

(73) Assignee: NINGBO INSTITUTE OF MATERIALS TECHNOLOGY AND ENGINEERING, CHINESE ACADEMY OF SCIENCES, Ningbo, Zhejiang (CN)

(21) Appl. No.: 18/026,592

(22) PCT Filed: Aug. 30, 2022
(86) PCT No.: PCT/CN2022/115755

§ 371 Date: Mar. 16, 2023

(30) Foreign Application Priority Data
Jul. 11, 2022 (CN) 202210808644.8

(51) Int. Cl. C08G 18/66; C08G 18/24; C08G 18/32; C08G 18/40; C08G 18/42; C08G 18/61; C08G 18/75

(52) U.S. Cl. CPC C08G 18/664; C08G 18/246; C08G 18/3206; C08G 18/4009; C08G 18/4277; C08G 18/61; C08G 18/758

(57) ABSTRACT

The present invention provides a method for preparing a thermoplastic elastomer with excellent resilience and high strength, comprising the steps of: A) adding at least two soft segment monomers into a solvent, and then adding a hard segment monomer to the mixture for reaction under the action of a catalyst to obtain an initial reactant; B) subjecting the initial reactant to react with a chain extending agent to obtain a thermoplastic elastomer. In the thermoplastic elastomer provided by the present application, the multiple hydrogen bonds in the hard segment monomer provide it with high strength and high modulus, and the thermodynamic incompatibility of the soft segment monomers provides it with excellent toughness and high resilience. Therefore, the thermoplastic elastomer provided by the present application has advantages of excellent strength, toughness, rapid resilience and high resilience rate.

### CROSS REFERENCE TO RELATED APPLICATIONS

This application claims the priority of Chinese Patent Application No. 202210808644.8, filed with the China National Intellectual Property Administration on Jul. 11, 2022, and titled with “THERMOPLASTIC ELASTOMER WITH EXCELLENT RESILIENCE AND HIGH STRENGTH AND PREPARATION METHOD THEREOF”, which is hereby incorporated by reference in its entirety.

### FIELD

The present invention relates to the field of polymer materials and thermoplastic elastomers, and in particular to a thermoplastic elastomer with excellent resilience and high strength and a preparation method thereof.

### BACKGROUND

Molecular chains of a thermoplastic elastomer usually consist of soft and hard segments. The soft segment aggregates to form a soft phase, which provides the material with excellent extensibility and toughness; and the hard segment enriches to form a hard phase, which provides the material with good strength and high modulus. Therefore, a variety of thermoplastic elastomers with diverse mechanical performances can be obtained by adjusting the structural parameters such as molecular structure and component ratio of the soft segment and the hard segment. In addition, the most significant structural feature of thermoplastic elastomers is that there is no chemical crosslinking in its system, and its hard phase forms physical crosslinking through non-covalent interactions such as hydrogen bonds and x-x stacking to provide the material with excellent mechanical performance and repeatable processability.

It is well known that polymers have significant viscoelasticity, and thermoplastic elastomers are prone to permanent deformation during a process of large deformation. Due to the affect of physical crosslinking, elastic deformation recovers slowly at the late stage of resilience, which is a fatal shortcoming for high-performance thermoplastic elastomers. How to solve this shortcoming is an unavoidable problem in the development of high-performance thermoplastic elastomers. In recent years, there have also been many research reports on how to improve resilience, for example, obtaining a certain resilience through a bionic spider silk structure (Adv. Mater. 2021, 33, 2101498), building a strong-weak hydrogen bond system to obtain resilience and toughness (Adv. Mater. 2018, 1706846), and integrating optical isomers to obtain resilience (Angew. Chem. Int. Ed. 2022, e202115904). However, during cyclic tensile process, these reported samples still had a residual strain rate as high as 15% or more, which still considerably differs from the high resilience rate (above 96%) of biological proteins (Nat. Mater. 2009, 8. 910).

Therefore, in order to meet the requirements of practical use, it is necessary to develop a thermoplastic elastomer that meets both high resilience and high strength, so that its deformation recovery rate during cyclic tensile process can be comparable to or even better than that of biological proteins.

### SUMMARY

The technical problem solved by the present invention is to provide a method for preparing a thermoplastic elastomer. The thermoplastic elastomer prepared in the present application has high resilience and high strength, rapid resilience and high resilience rate.

In view of this, the present application provides a method for preparing a thermoplastic elastomer with excellent resilience and high strength, comprising the steps of:
A) adding at least two soft segment monomers into a solvent, and then adding a hard segment monomer to the mixture for reaction to obtain an initial reactant;
B) subjecting the initial reactant to react with a chain extending agent to obtain a thermoplastic elastomer;
wherein, the soft segment monomer exhibits thermodynamical incompatibility.

Preferably, the soft segment monomer is two or more selected from the group consisting of thermodynamically incompatible diol oligomer and/or diamine oligomer.

Preferably, the diol oligomer is selected from the group consisting of polycaprolactone diol, polytetrahydrofuran diol, double hydroxyl terminated polyethylene glycol, double hydroxyl terminated polypropylene glycol, double hydroxyl terminated polydimethylsiloxane and a mixture thereof, and has a number-average molecular weight of 200-5000 g/mol; the diamine oligomer is selected from the group consisting of polyetheramine, double amino terminated polydimethylsiloxane and a mixture thereof, and has a number-average molecular weight of 200-5000 g/mol; the hard segment monomer is diisocyanate, and the diisocyanate is selected from the group consisting of isophorone diisocyanate, hexamethylene diisocyanate, trimethylhexadimethyl diisocyanate, dicyclohexyl methane 4,4′-diisocyanate, p-phenylene diisocyanate, toluene diisocyanate and a mixture thereof.

Preferably, a molar ratio of the soft segment monomer to the hard segment monomer is (1-20):(2-21).

Preferably, in case that there are two kinds of soft segment monomers, a molar ratio of the two soft segment monomers is (1-20):(1-20).

Preferably, in step A), the reaction process includes a catalyst, wherein the catalyst is selected from organotin catalyst, the organotin catalyst is selected from dibutyltin dilaurate, and an amount of the catalyst is equal to or less than 1 wt % of the total amount of the soft segment monomer and the hard segment monomer.

Preferably, the chain extending agent is selected from the group consisting of 1,4-butanediol, 1,4-butanediol, 1,2-ethanediol, diethylene glycol, 1,6-hexanediol, hydroquinone bis(2-hydroxyethyl)ether, meso-hydrobenzoin, 1,2-ethylenediamine, 1,4-butanediamine, 1,6-hexanediamine, 1,8-octanediamine, oxalyl dihydrazide, succinic dihydrazide, adipic dihydrazide, isophthalic dihydrazide, adipamide and a mixture thereof; and a molar ratio of the chain extending agent to the hard segment monomer is (1-5): (2-40).

Preferably, in step A), the reaction is carried out at 40-100° C. for 5-120 min; and in step B), the reaction is carried out at 40-100° C. for 30-1200 min.

The present application also provides a thermoplastic elastomer prepared by the preparation method.

Preferably, the thermoplastic elastomer has a deformation recovery rate of 84.5-95%, and a resilience rate of 95-100% after unloading the stress.

The present application provides a thermoplastic elastomer with high resilience and high strength, in which the multiple hydrogen bonds in the hard segment monomer provide it with high strength and high modulus, and the thermodynamic incompatibility between at least two soft segment monomers provides it with excellent toughness and high resilience. Furthermore, during the preparation process, effective control of material performance can be achieved by adjusting the composition of soft segment monomers, the ratio of soft/hard segments, and the type of chain extending agent. The experimental results show that the thermoplastic elastomer with high resilience and high strength of the present invention has a tensile strength as high as 80 MPa and an elongation rate at break close to 1000%. In case that the uniaxial tensile deformation reaches a large deformation of 800%, the thermoplastic elastomer still has a rapid deformation recovery rate of 96%, which is comparable to biological proteins, and it can achieve full recovery of strength within 1 min. In a compression test, it is found that in case that the compression deformation reaches 90%, the thermoplastic elastomer can still have a deformation recovery rate of 100%, showing an excellent recovery ability from deformation.

### BRIEF DESCRIPTION OF DRAWINGS

FIG. 1 is the compressive stress-strain curve of the thermoplastic elastomer prepared in Example 2 of the present invention;

FIG. 2 is the uniaxial cyclic tensile stress-strain curve of the thermoplastic elastomer prepared in Example 3 of the present invention;

FIG. 3 is the uniaxial cyclic tensile stress-strain curve of the thermoplastic elastomer prepared in Example 4 of the present invention;

FIG. 4 is the uniaxial tensile stress-strain curve of the thermoplastic elastomer prepared in Example 5 of the present invention;

FIG. 5 is the uniaxial cyclic tensile stress-strain curve of the thermoplastic elastomer prepared in Example 5 of the present invention;

FIG. 6 is the compressive stress-strain curve of the thermoplastic elastomer prepared in Example 5 of the present invention;

FIG. 7 is the uniaxial tensile stress-strain curve of the thermoplastic elastomer prepared in Example 6 of the present invention;

FIG. 8 is the uniaxial tensile stress-strain curve of the thermoplastic elastomer prepared in Example 7 of the present invention;

FIG. 9 is the uniaxial tensile stress-strain curve of the thermoplastic elastomer prepared in Example 8 of the present invention;

FIG. 10 is the uniaxial cyclic tensile stress-strain curve of the thermoplastic elastomer prepared in Comparative Example 1 of the present invention.

### DETAILED DESCRIPTION

In order to further understand the present invention, the preferred embodiments of the present invention are described below in conjunction with examples, but it should be understood that these descriptions are only to further illustrate the features and advantages of the present invention, rather than limiting the claims of the present invention.

In view of the problem in the prior art that thermoplastic elastomers are prone to permanent plastic deformation when subjected to large deformation, resulting in poor resilience, the present application provides a method for preparing a thermoplastic elastomer with excellent resilience and high strength. In the thermoplastic elastomer of the present invention, the synergistic effect between the soft segment monomer and the hard segment monomer provides the thermoplastic elastomer with high strength and toughness. The spontaneous phase separation process between the components of the soft segment monomer is conducive to maintaining a low Gibbs free energy, and provides the thermoplastic elastomer with an excellent recovery ability from deformation. In addition, effective regulation of comprehensive performance of the thermoplastic elastomer is realized through a synergistic coupling effect between multiple phases. Specifically, the present application provides a method for preparing a thermoplastic elastomer with excellent resilience and high strength, comprising the steps of:
A) adding at least two soft segment monomers into a solvent, and then adding a hard segment monomer to the mixture for reaction under the action of a catalyst to obtain an initial reactant;
B) subjecting the initial reactant to react with a chain extending agent to obtain a thermoplastic elastomer;
wherein, the soft segment monomer exhibits thermodynamical incompatibility.

In the preparation process of the thermoplastic elastomer of the present application, firstly, a soft segment monomer is dissolved in a solvent, and then the mixture is added with an excess amount of hard segment monomer for reaction to obtain an oligomer with isocyanate at both ends. In this process, the soft segment monomer is selected from two or more monomers, which have thermodynamic incompatibility to maintain a low Gibbs free energy, so that the thermoplastic elastomer has excellent recovery ability from deformation. The soft segment monomer is two or more selected from the group consisting of diol oligomer and/or diamine oligomer, namely, the soft segment monomer may be at least two diol oligomers, at least two diamine oligomers, or at least one diol oligomer and at least one diamine oligomer. More specifically, the diol oligomer includes but is not limited to polycaprolactone diol, polytetrahydrofuran diol, double hydroxyl terminated polyethylene glycol, double hydroxyl terminated polypropylene glycol, double hydroxyl terminated polydimethylsiloxane or a mixture thereof, and has a number-average molecular weight of 200-5000 g/mol. In a specific embodiment, the diol oligomer is selected from two of f polycaprolactone diol, polytetrahydrofuran diol, and double hydroxyl terminated polyethylene glycol, and has a number-average molecular weight of 1000-4000 g/mol. The diamine oligomer is selected from one or both of polyetheramine and double amino terminated polydimethylsiloxane, and has a number-average molecular weight of 200-5000 g/mol. In a specific embodiment, the diamine oligomer is selected from polyetheramine. The hard segment monomer is isocyanate, including but not limited to isophorone diisocyanate, hexamethylene diisocyanate, trimethylhexadimethyl diisocyanate, dicyclohexyl methane 4,4′-diisocyanate, p-phenylene diisocyanate, toluene diisocyanate and a mixture thereof. Specifically, the hard segment monomer is selected from dicyclohexyl methane 4,4′-diisocyanate. In the above-mentioned reaction process, a catalyst can be selectively added as required, wherein the catalyst is added at a trace amount, and is selected from organotin catalyst, the organotin catalyst is selected from dibutyltin dilaurate, and an amount of the catalyst is equal to or less than 1 wt % of the total amount of the soft segment monomer and the hard segment monomer.

In the present application, a molar ratio of the soft segment monomer to the hard segment monomer is (1-20):(2-21), more specifically, a molar ratio of the soft segment monomer to the hard segment monomer is (2-18):(4-18). In case that two kinds of soft segment monomers are selected, a molar ratio of the two soft segment monomers is (1-20):(1-20), more specifically, a molar ratio of the two soft segment monomers is (2-18):(2-18). The catalyst is selected from dibutyltin dilaurate, and an amount of the catalyst is equal to or less than 1 wt % of the reaction raw materials. The solvent is selected from the group consisting of N,N′-dimethylformamide, N,N′-dimethylacetamide, tetrahydrofuran, chloroform and a mixture thereof. The reaction is carried out at 40-100° C. for 5-120 min; and more specifically, the reaction is carried out at 60-80° C. for 20-100 min.

In the present application, a chain extending agent is then added to the reactant obtained above to react with the initial reactant to obtain a thermoplastic elastomer. In this process, the chain extending agent includes but is not limited to 1,4-butanediol, 1,2-ethanediol, diethylene glycol, 1,6-hexanediol, hydroquinone bis(2-hydroxyethyl)ether, meso-hydrobenzoin, 1,2-ethylenediamine, 1,4-butanediamine, 1,6-hexanediamine, 1,8-octanediamine, oxalyl dihydrazide, succinic dihydrazide, adipamide or a mixture thereof; more specifically, the chain extending agent is selected from the group consisting of 1,4-butanediol, oxalyl dihydrazide, adipic dihydrazide, and isophthalic dihydrazide. A molar ratio of the chain extending agent to the hard segment monomer is (1-5): (2-40), specifically, a molar ratio of the chain extending agent to the hard segment monomer is (1-5):(3-10). The reaction is carried out at 40-100° C. for 30-1200 min; and specifically, the reaction is carried out at 60-80° C. for 5 h-15 h.

In the present application, two or more soft segment monomers are simultaneously introduced into a thermoplastic elastomer utilizing the property of spontaneous phase separation of thermodynamically incompatible polymers to prepare a thermoplastic elastomer with high resilience and high strength. In the above preparation process, by adjusting the composition of soft segment monomers, the number and proportion of soft segment monomers, a soft phase based on multiple microscopic phases separation is obtained, which provides the thermoplastic elastomer with excellent recovery ability from deformation. Moreover, the synergistic coupling effect of the soft segment monomers and the hard segment monomers provides the thermoplastic elastomer with high strength. The experimental results show that the thermoplastic elastomer with high resilience and high strength of the present invention has a tensile strength as high as 80 MPa and an elongation rate at break close to 1000%. In case that the uniaxial tensile deformation reaches a large deformation of 800%, the thermoplastic elastomer still has a rapid deformation recovery rate of 96%, which is comparable to biological proteins, and it can achieve full recovery of strength within 1 min. In a compression test, it is found that in case that the compression deformation reaches 90%, the thermoplastic elastomer can still have a deformation recovery rate of 100%, showing an excellent recovery ability from deformation.

In order to further understand the present invention, the method for preparing the thermoplastic elastomer with excellent resilience and high strength provided by the present invention will be described in detail below in conjunction with the examples, and the protection scope of the present invention is not limited by the following examples.

### Example 1

A method for preparing a thermoplastic elastomer material with high resilience and high strength comprises the following steps:
S1. Polycaprolactone diol and double hydroxyl terminated polydimethylsiloxane were completely dissolved in N,N′-dimethylformamide, and the mixture was removed off air bubbles, and added with a small amount of catalyst and an excess amount of dicyclohexyl methane 4,4′-diisocyanate for reaction at 60° C. for 60 min to obtain an oligomer with isocyanate at both ends;
S2. 1,4-butanediol was added into the reaction environment of S1 as a chain extending agent to react with the initial reactant obtained in S1 at 60° C. for 20 h;
S3. After the S2 reaction was completed, the reaction product was dried to obtain a thermoplastic elastomer material with high resilience and high strength;
wherein, in S1, a molar ratio of the polycaprolactone diol to the double hydroxyl terminated polydimethylsiloxane was 1:1;
wherein, in S1, a molar ratio of the sum of the amount of substance of the polycaprolactone diol and double hydroxyl terminated polydimethylsiloxane to the dicyclohexyl methane 4,4′-diisocyanate was 2:3;
wherein, in S1, the polycaprolactone diol and the double hydroxyl terminated polydimethylsiloxane had relative molecular masses of 2000 g/mol and 2000 g/mol respectively;
wherein, in S2, a molar ratio of the 1,4-butanediol to the sum of the amount of substance of polycaprolactone diol and double-terminated hydroxyl polydimethylsiloxane was 1:2.

### Example 2

A method for preparing a thermoplastic elastomer material with high resilience and high strength comprises the following steps:
S1. Polycaprolactone diol and polytetrahydrofuran diol were completely dissolved in N,N′-dimethylformamide, and the mixture was removed off air bubbles, and added with a small amount of catalyst and an excess amount of dicyclohexyl methane 4,4′-diisocyanate for reaction at 60° C. for 60 min to obtain an oligomer with isocyanate at both ends;
S2. 1,4-butanediol was added into the reaction environment of S1 as a chain extending agent to react with the initial reactant obtained in S1 at 60° C. for 20 h;
S3. After the S2 reaction was completed, the reaction product was dried to obtain a thermoplastic elastomer material with high resilience and high strength;
wherein, in S1, a molar ratio of the polycaprolactone diol to the polytetrahydrofuran diol was 1:1;
wherein, in S1, a molar ratio of the sum of the amount of substance of the polycaprolactone diol and polytetrahydrofuran diol to the dicyclohexyl methane 4,4′-diisocyanate was 2:3;
wherein, in S1, the polycaprolactone diol and the polytetrahydrofuran diol had relative molecular masses of 2000 g/mol and 2000 g/mol respectively;
wherein, in S2, a molar ratio of the 1,4-butanediol to the sum of the amount of substance of the polycaprolactone diol and polytetrahydrofuran diol was 1:2.

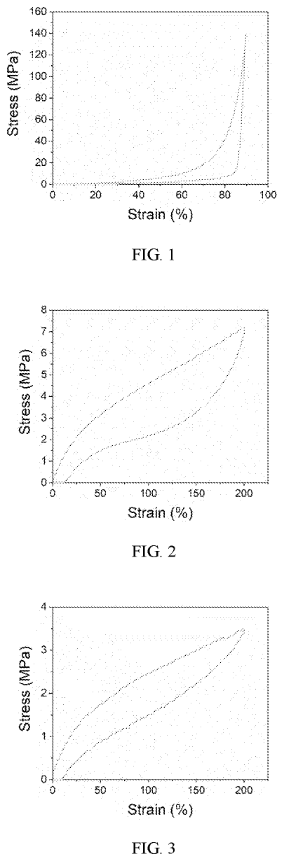

FIG. 1 is the compressive stress-strain curve of the thermoplastic elastomer prepared in this example. It can be seen from FIG. 1 that the thermoplastic elastomer exhibited very excellent compressive deformation ability. When the compressive deformation reached 90%, the thermoplastic elastomer can still maintain deformation without being broken, in which case the compressive strength can reach as high as 140 MPa, which is better than other thermoplastic elastomers reported in the same category. More importantly, after unloading the stress, the thermoplastic elastomer can immediately recover the strain to 0%, namely, its resilience rate can reach 100%, showing excellent recovery ability from compressive deformation.

### Example 3

A method for preparing a thermoplastic elastomer material with high resilience and high strength comprises the following steps:
S1. Double amino terminated polydimethylsiloxane and polytetrahydrofuran diol were completely dissolved in N,N′-dimethylformamide, and the mixture was removed off air bubbles, and added with a small amount of catalyst and an excess amount of hexamethylene diisocyanate for reaction at 60° C. for 60 min to obtain an oligomer with isocyanate at both ends;
S2. Isophthalic dihydrazide was added into the reaction environment of S1 as a chain extending agent to react with the initial reactant obtained in S1 at 60° C. for 20 h;
S3. After the S2 reaction was completed, the reaction product was dried to obtain a thermoplastic elastomer material with high resilience and high strength;
wherein, in S1, a molar ratio of the double amino terminated polydimethylsiloxane to the polytetrahydrofuran diol was 1:1;
wherein, in S1, a molar ratio of the sum of the amount of substance of the double amino terminated polydimethylsiloxane and polytetrahydrofuran diol to the hexamethylene diisocyanate was 2:3;
wherein, in S1, the double amino terminated polydimethylsiloxane and the polytetrahydrofuran diol had relative molecular masses of 2000 g/mol and 2000 g/mol respectively;
wherein, in S2, a molar ratio of the isophthalic dihydrazide to the sum of the amount of substance of the double amino terminated polydimethylsiloxane and polytetrahydrofuran diol was 1:2.

FIG. 2 is the uniaxial cyclic tensile stress-strain curve of the thermoplastic elastomer prepared in this example. It can be seen from FIG. 2 that the thermoplastic elastomer exhibited excellent tensile strength. In case that the strain was 200%, the thermoplastic elastomer can reach a tensile strength of 7 MPa. More importantly, after unloading the stress, the thermoplastic elastomer can immediately recover the strain to 25%, which can reach a deformation recovery rate of 87.5% calculated according to a strain of 100%, showing good recovery ability from deformation.

### Example 4

A method for preparing a thermoplastic elastomer material with high resilience and high strength comprises the following steps:
S1. Double amino terminated polydimethylsiloxane and polycaprolactone diol were completely dissolved in N,N′-dimethylformamide, and the mixture was removed off air bubbles, and added with a small amount of catalyst and an excess amount of hexamethylene diisocyanate for reaction at 60° C. for 60 min to obtain an oligomer with isocyanate at both ends;
S2. Oxalyl dihydrazide was added into the reaction environment of S1 as a chain extending agent to react with the initial reactant obtained in S1 at 60° C. for 20 h;
S3. After the S2 reaction was completed, the reaction product was dried to obtain a thermoplastic elastomer material with high resilience and high strength;
wherein, in S1, a molar ratio of the double amino terminated polydimethylsiloxane to the polycaprolactone diol was 1:1;
wherein, in S1, a molar ratio of the sum of the amount of substance of the double amino terminated polydimethylsiloxane and polycaprolactone diol to the hexamethylene diisocyanate was 2:3;
wherein, in S1, the double amino terminated polydimethylsiloxane and the polycaprolactone diol had relative molecular masses of 2000 g/mol and 2000 g/mol respectively;
wherein, in S2, a molar ratio of the oxalyl dihydrazide to the sum of the amount of substance of the double amino terminated polydimethylsiloxane and polycaprolactone diol was 1:2.

FIG. 3 is the uniaxial cyclic tensile stress-strain curve of the thermoplastic elastomer prepared in this example. It can be seen from FIG. 3 that the thermoplastic elastomer exhibited good tensile strength. In case that the strain was 200%, the thermoplastic elastomer can reach a tensile strength of 3.5 MPa. More importantly, after unloading the stress, the thermoplastic elastomer can immediately recover the strain to 20%, which can reach a deformation recovery rate of 90% calculated according to a strain of 100%, showing excellent recovery ability from deformation.

### Example 5

A method for preparing a thermoplastic elastomer material with high resilience and high strength comprises the following steps:
S1. Polycaprolactone diol and polytetrahydrofuran diol were completely dissolved in N,N′-dimethylformamide, and the mixture was removed off air bubbles, and added with a small amount of catalyst and an excess amount of dicyclohexyl methane 4,4′-diisocyanate for reaction at 60° C. for 60 min to obtain an oligomer with isocyanate at both ends;
S2. Adipic dihydrazide was added into the reaction environment of S1 as a chain extending agent to react with the initial reactant obtained in S1 at 60° C. for 20 h;
S3. After the S2 reaction was completed, the reaction product was dried to obtain a thermoplastic elastomer material with high resilience and high strength;
wherein, in S1, a molar ratio of the polycaprolactone diol to the polytetrahydrofuran diol was 1:1;
wherein, in S1, a molar ratio of the sum of the amount of substance of the polycaprolactone diol and polytetrahydrofuran diol to the dicyclohexyl methane 4,4′-diisocyanate was 2:3;
wherein, in S1, the polycaprolactone diol and the polytetrahydrofuran diol had relative molecular masses of 2000 g/mol and 2000 g/mol respectively;
wherein, in S2, a molar ratio of the adipic dihydrazide to the sum of the amount of substance of the polycaprolactone diol and polytetrahydrofuran diol was 1:2.

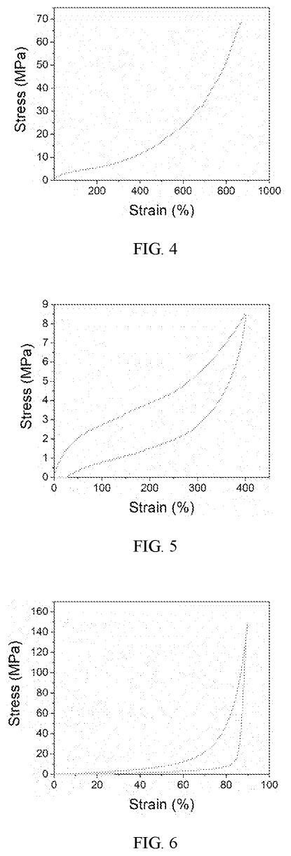

FIG. 4 is the uniaxial tensile stress-strain curve of the thermoplastic elastomer prepared in this example. It can be seen from FIG. 4 that the thermoplastic elastomer can reach a tensile strength as high as 70 MPa, and an elongation rate at break equal to or more than 900%, showing excellent mechanical performance.

FIG. 5 is the uniaxial cyclic tensile stress-strain curve of the thermoplastic elastomer prepared in this example. It can be seen from FIG. 5 that in case that the strain was 400%, the thermoplastic elastomer can reach a tensile strength of 8.5 MPa, exhibiting good tensile strength. More importantly, after unloading the stress, the thermoplastic elastomer can immediately recover the strain to 25%, which can reach a deformation recovery rate of 95% calculated according to a strain of 100%. It has a deformation resilience ability comparable to that of biological proteins, exhibiting excellent deformation resilience ability.

FIG. 6 is the compressive stress-strain curve of the thermoplastic elastomer prepared in this example. It can be seen from FIG. 6 that the thermoplastic elastomer exhibits very excellent compression deformation ability. When the compression deformation reached 90%, the thermoplastic elastomer can still maintain deformation without being broken, in which case the compressive strength can reach as high as 150 MPa, which is better than other thermoplastic elastomers reported in the same category. More importantly, after unloading the stress, the thermoplastic elastomer can immediately recover the strain to 0%, namely, its resilience rate can reach 100%, showing extremely excellent recovery ability from compressive deformation.

### Example 6

A method for preparing a thermoplastic elastomer material with high resilience and high strength comprises the following steps:
S1. Polycaprolactone diol and polytetrahydrofuran diol were completely dissolved in N, N′-dimethylformamide, and the mixture was removed off air bubbles, and added with a small amount of catalyst and an excess amount of dicyclohexyl methane 4,4′-diisocyanate for reaction at 60° C. for 60 min to obtain an oligomer with isocyanate at both ends;
S2. Adipic dihydrazide was added into the reaction environment of S1 as a chain extending agent to react with the initial reactant obtained in S1 at 60° C. for 20 h;
S3. After the S2 reaction was completed, the reaction product was dried to obtain a thermoplastic elastomer material with high resilience and high strength;
wherein, in S1, a molar ratio of the polycaprolactone diol to the polytetrahydrofuran diol was 1:1;
wherein, in S1, a molar ratio of the sum of the amount of substance of the polycaprolactone diol and polytetrahydrofuran diol to the dicyclohexyl methane 4,4′-diisocyanate was 1:2;
wherein, in S1, the polycaprolactone diol and the polytetrahydrofuran diol had relative molecular masses of 2000 g/mol and 2000 g/mol respectively;
wherein, in S2, a molar ratio of the adipic dihydrazide to the sum of the amount of substance of the polycaprolactone diol and polytetrahydrofuran diol was 1:1.

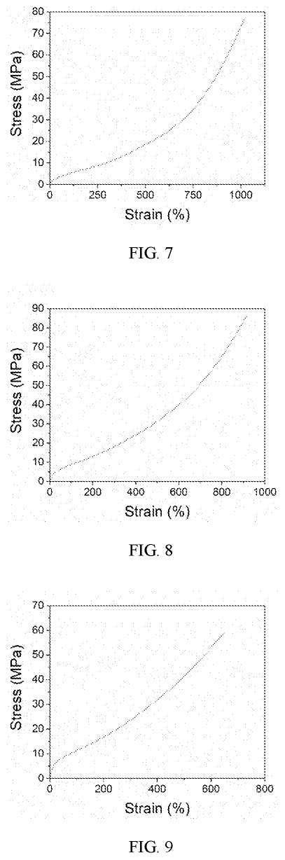

FIG. 7 is the uniaxial tensile stress-strain curve of the thermoplastic elastomer prepared in this example. It can be seen from FIG. 7 that the thermoplastic elastomer can reach a tensile strength as high as 75 MPa, and an elongation rate at break equal to or more than 1000%, showing excellent mechanical performance.

### Example 7

A method for preparing a thermoplastic elastomer material with high resilience and high strength comprises the following steps:
S1. Polycaprolactone diol and polyetheramine D2000 were completely dissolved in N,N′-dimethylformamide, and the mixture was removed off air bubbles, and added with a small amount of catalyst and an excess amount of dicyclohexyl methane 4,4′-diisocyanate for reaction at 60° C. for 60 min to obtain an oligomer with isocyanate at both ends;
S2. Adipic dihydrazide was added into the reaction environment of S1 as a chain extending agent to react with the initial reactant obtained in S1 at 60° C. for 20 h;
S3. After the S2 reaction was completed, the reaction product was dried to obtain a thermoplastic elastomer material with high resilience and high strength;
wherein, in S1, a molar ratio of the polycaprolactone diol to the polyetheramine D2000 was 1:1;
wherein, in S1, a molar ratio of the sum of the amount of substance of the polycaprolactone diol and polyetheramine D2000 to the dicyclohexyl methane 4,4′-diisocyanate was 1:2;
wherein, in S1, the polycaprolactone diol and the polyetheramine D2000 had relative molecular masses of 2000 g/mol and 1000 g/mol respectively;
wherein, in S2, a molar ratio of the adipic dihydrazide to the sum of the amount of substance of the polycaprolactone diol and polyetheramine D2000 was 1:1.

FIG. 8 is the uniaxial tensile stress-strain curve of the thermoplastic elastomer prepared in this example. It can be seen from FIG. 8 that the thermoplastic elastomer can reach a tensile strength as high as 85 MPa, and an elongation rate at break equal to or more than 900%, showing excellent mechanical performance.

### Example 8

A method for preparing a thermoplastic elastomer material with high resilience and high strength comprises the following steps:
S1. Polyetheramine D2000 and polytetrahydrofuran diol were completely dissolved in N,N′-dimethylformamide, and the mixture was removed off air bubbles, and added with a small amount of catalyst and an excess amount of dicyclohexyl methane 4,4′-diisocyanate for reaction at 60° C. for 60 min to obtain an oligomer with isocyanate at both ends;
S2. Adipic dihydrazide was added into the reaction environment of S1 as a chain extending agent to react with the initial reactant obtained in S1 at 60° C. for 20 h;
S3. After the S2 reaction was completed, the reaction product was dried to obtain a thermoplastic elastomer material with high resilience and high strength;
wherein, in S1, a molar ratio of the polyetheramine D2000 to the polytetrahydrofuran diol was 1:1;
wherein, in S1, a molar ratio of the sum of the amount of substance of the polyetheramine D2000 and polytetrahydrofuran diol to the dicyclohexyl methane 4,4′-diisocyanate was 2:3;
wherein, in S1, the polyetheramine D2000 and the polytetrahydrofuran diol had relative molecular masses of 2000 g/mol and 2000 g/mol respectively;
wherein, in S2, a molar ratio of the adipic dihydrazide to the sum of the amount of substance of the polycaprolactone diol and polytetrahydrofuran diol was 1:2.

FIG. 9 is the uniaxial tensile stress-strain curve of the thermoplastic elastomer prepared in this example. It can be seen from FIG. 9 that the thermoplastic elastomer can reach a tensile strength as high as 60 MPa, and an elongation rate at break equal to or more than 700%, showing good mechanical performance.

### Comparative Example 1

S1. Polytetrahydrofuran diol was completely dissolved in N,N′-dimethylformamide, and the mixture was removed off air bubbles, and added with a small amount of catalyst and an excess amount of dicyclohexyl methane 4,4′-diisocyanate for reaction at 60° C. for 60 min to obtain an oligomer with isocyanate at both ends;

S2. Adipic dihydrazide was added into the reaction environment of S1 as a chain extending agent to react with the initial reactant obtained in S1 at 60° C. for 20 h;

S3. After the S2 reaction was completed, the reaction product was dried to obtain a thermoplastic elastomer material with high resilience and high strength;
wherein, in S1, a molar ratio of the amount of substance of the polytetrahydrofuran diol to the dicyclohexyl methane 4,4′-diisocyanate was 1:2;
wherein, in S1, the polytetrahydrofuran diol had a relative molecular mass of 2000 g/mol;
wherein, in S2, a molar ratio of the adipic dihydrazide to the amount of substance of the polytetrahydrofuran diol was 1:1.

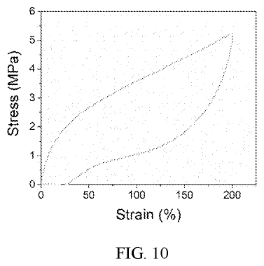

FIG. 10 is the uniaxial cyclic tensile stress-strain curve of the thermoplastic elastomer prepared in this example. It can be seen from FIG. 10 that in case that the strain was 200%, the thermoplastic elastomer can reach a tensile strength of 5.2 MPa, showing normal tensile strength. More importantly, after unloading the stress, the thermoplastic elastomer can immediately recover the strain to 60%, which can reach a deformation recovery rate of 70% calculated according to a strain of 100%, showing normal deformation resilience ability.

The descriptions of the above examples are only used to help understand the method and core idea of the present invention. It should be noted that for those of ordinary skill in the art, several improvements and modifications can be made to the present invention without departing from the principle of the present invention, and these improvements and modifications also fall within the protection scope of the claims of the present invention.

The above description of the disclosed examples is provided to enable those skilled in the art to implement or use the present invention. Various modifications to these examples will be apparent to those skilled in the art. The general principles defined herein may be implemented in other embodiments without departing from the spirit or scope of the present invention. Therefore, the present invention will not be limited to the examples shown herein, but is to be accorded the widest scope consistent with the principles and novel features disclosed herein.

1. A method for preparing a thermoplastic elastomer with excellent resilience and high strength, comprising the steps of:
A) adding at least two soft segment monomers into a solvent, and then adding a hard segment monomer to the mixture for reaction to obtain an initial reactant;
B) subjecting the initial reactant to react with a chain extending agent to obtain a thermoplastic elastomer;
wherein, the soft segment monomer exhibits thermodynamical incompatibility.

2. The method according to claim 1, wherein the soft segment monomer is two or more selected from the group consisting of thermodynamically incompatible diol oligomer and/or diamine oligomer.

3. The method according to claim 2, wherein the diol oligomer is selected from the group consisting of polycaprolactone diol, polytetrahydrofuran diol, double hydroxyl terminated polyethylene glycol, double hydroxyl terminated polypropylene glycol, double hydroxyl terminated polydimethylsiloxane and a mixture thereof, and has a number-average molecular weight of 200-5000 g/mol; the diamine oligomer is selected from the group consisting of polyetheramine, double amino terminated polydimethylsiloxane and a mixture thereof, and has a number-average molecular weight of 200-5000 g/mol; the hard segment monomer is diisocyanate, and the diisocyanate is selected from the group consisting of isophorone diisocyanate, hexamethylene diisocyanate, trimethylhexadimethyl diisocyanate, dicyclohexyl methane 4,4′-diisocyanate, p-phenylene diisocyanate, toluene diisocyanate and a mixture thereof.

4. The method according to claim 1, wherein a molar ratio of the soft segment monomer to the hard segment monomer is (1-20):(2-21).

5. The method according to claim 2, wherein in case that there are two kinds of soft segment monomers, a molar ratio of the two soft segment monomers is (1-20):(1-20).

6. The method according to claim 1, wherein in step A), the reaction process includes a catalyst, wherein the catalyst is selected from organotin catalyst, the organotin catalyst is selected from dibutyltin dilaurate, and an amount of the catalyst is equal to or less than 1 wt % of the total amount of the soft segment monomer and the hard segment monomer.

7. The method according to claim 1, wherein the chain extending agent is selected from the group consisting of 1,4-butanediol, 1,4-butanediol, 1,2-ethanediol, diethylene glycol, 1,6-hexanediol, hydroquinone bis(2-hydroxyethyl)ether, meso-hydrobenzoin, 1,2-ethylenediamine, 1,4-butanediamine, 1,6-hexanediamine, 1,8-octanediamine, oxalyl dihydrazide, succinic dihydrazide, adipic dihydrazide, isophthalic dihydrazide, adipamide and a mixture thereof; and a molar ratio of the chain extending agent to the hard segment monomer is (1-5):(2-40).

8. The method according to claim 1, wherein in step A), the reaction is carried out at 40-100° C. for 5-120 min; and in step B), the reaction is carried out at 40-100° C. for 30-1200 min.

9. A thermoplastic elastomer prepared by the method according to claim 1.

10. The thermoplastic elastomer according to claim 9, wherein the thermoplastic elastomer has a deformation recovery rate of 84.5-95%, and a resilience rate of 95-100% after unloading the stress.
